(19) United States
(12) Patent Application Publication
(10) Pub. No.: US 2019/0333170 A1
(43) Pub. Date: Oct. 31, 2019

(54) SYSTEM AND METHOD FOR CONSTRUCTION PROJECT ADMINISTRATION

(71) Applicant: Moda Holdings, LLC, Astoria, NY (US)

(72) Inventor: John Paul Moda, Astoria, NY (US)

(21) Appl. No.: 16/395,556

(22) Filed: Apr. 26, 2019

Related U.S. Application Data
(60) Provisional application No. 62/663,524, filed on Apr. 27, 2018.

(51) Int. Cl. G06Q 50/08; G06F 16/25; G06Q 30/06; G06Q 10/06

(52) U.S. Cl. CPC G06Q 50/08; G06F 16/25; G06Q 10/063118; G06Q 10/06313; G06Q 10/063116; G06Q 30/0613

(57) ABSTRACT

An apparatus in one embodiment comprises at least one processor coupled to a memory. The processor is configured to interface with at least one administrative user of an organization and a plurality of non-administrative users, to associate a subset of the plurality of non-administrative users with a job being performed by the organization, and to transmit one or more messages from the administrative user to the subset of the plurality of non-administrative users associated with the job. In transmitting the one or messages, the processor is configured to receive an input from the administrative user associating the one or messages with the job, and to assign the subset of the plurality of non-administrative users associated with the job as recipients of the one or more messages in response to the input from the administrative user.

### FIELD

The field generally relates to the construction industry, and more particularly technological solutions for efficient control and management of a construction operation.

### BACKGROUND

Due to a variety of factors, the efficient and effective management of commercial construction projects is difficult and labor intensive. Many construction companies who contract with municipalities, such as state and local governments, to provide construction services must efficiently and effectively manage and administrate multiple construction jobs. This requires the completion of multiple forms, often times in an inefficient manner. Additionally, the management of employees, laborers, and third parties is difficult and time consuming as there are multiple layers and channels of communication to traverse. Further, with regard to a construction job performed outdoors, for example road paving, various weather factors dictate whether a job can be performed. In many instances, laborers will arrive at a job site and then learn that it is not possible to perform a job due to weather related factors. In general, all laborers who arrive at the jobsite without knowledge that a job has been canceled must be compensated for their time. A need therefore exists for a central interface and system for organizing, managing and administrating over a construction organization.

### SUMMARY

According to an exemplary embodiment of the present invention, a construction management system is provided which utilizes multiple modules and functionality, which contribute to the efficient organization and operation of a construction entity.

In one embodiment, an apparatus comprises at least one processor coupled to a memory. The at least one processor is configured to interface with at least one administrative user of an organization and a plurality of non-administrative users, to associate a subset of the plurality of non-administrative users with a job being performed by the organization, and to transmit one or more messages from the at least one administrative user to the subset of the plurality of non-administrative users associated with the job. In transmitting the one or messages, the at least one processor is configured to receive an input from the at least one administrative user associating the one or messages with the job, and to assign the subset of the plurality of non-administrative users associated with the job as recipients of the one or more messages in response to the input from the at least one administrative user.

A plurality of reply messages to the one or more messages may be received from the subset of the plurality of non-administrative users associated with the job. The reply messages may be aggregated for viewing by the at least one administrative user.

According to one or more embodiments, the at least one processor is further configured to maintain a database of a plurality of messages, and to present to the at least one administrative user the plurality of messages for selection as the one or more messages. A selection of at least one message of the plurality of messages as the one or more messages is received from the at least one administrative user, and the one or more messages are automatically transmitted to the subset of the plurality of non-administrative users associated with the job in response to the selection.

According to one or more embodiments, the at least one processor is further configured to receive an input from the at least one administrative user canceling the job, and to automatically transmit a message to the subset of the plurality of non-administrative users associated with the job alerting the subset of the plurality of non-administrative users of the cancellation.

In addition, one or more external conditions affecting the job are automatically monitored. In the event that the one or more external conditions are determined to occur, a message indicating a modification to the job is automatically transmitted to the subset of the plurality of non-administrative users associated with the job. In an embodiment, the one or more external conditions comprise a threshold temperature at a jobsite. The message indicates a cancellation of the job in response to reaching the threshold temperature. In another embodiment, the one or more external conditions comprise a problem associated with a route to a jobsite, and the message indicates the problem associated with the route and/or an alternate route to the jobsite in response to the occurrence of the problem associated with the route.

According to one or more embodiments, the at least one processor is further configured to receive a query from the at least one administrative user and/or at least one non-administrative user of the plurality of non-administrative users indicating work to be performed, and to respond to the query with at least one of supplies and materials needed for the work. In response to the query, there may be an indication of which of the needed supplies or materials are in stock by the organization.

According to one or more embodiments, the at least one processor is further configured to derive a description of material and/or equipment needed for the job from a photographic image of the material and/or the equipment. The derived description may include a size of the material and/or the equipment. The at least one processor may also be further configured to receive competitive bids in real-time from a plurality of vendors for supplying material and/or equipment needed for the job.

According to one or more embodiments, an image of a payment instrument for an invoice can be received and linked to the invoice, and a status of the invoice can be updated to indicate that the invoice has been paid.

These and other illustrative embodiments include, without limitation, apparatus, systems, methods and computer program products comprising processor-readable storage media.

### BRIEF DESCRIPTION OF THE DRAWINGS

Exemplary embodiments of the present invention will be described below in more detail, with reference to the accompanying drawings, of which:

FIG. 1 is block diagram of a system for administration of a construction entity, according to an exemplary embodiment of the present invention;

FIG. 2 is an expanded block diagram of the management module of the system for administration of a construction entity, according to an exemplary embodiment of the present invention;

FIG. 3 is an expanded block diagram of the communications module of the system for administration of a construction entity, according to an exemplary embodiment of the present invention;

FIG. 4 is a flow diagram illustrating streamlined communications functionality, according to an exemplary embodiment of the present invention;

FIG. 5 is an expanded block diagram of the marketplace and inventory modules of the system for administration of a construction entity, according to an exemplary embodiment of the present invention;

FIG. 6 is an expanded block diagram of the billing/accounting module of the system for administration of a construction entity, according to an exemplary embodiment of the present invention;

FIG. 7 illustrates a computer system in accordance with which one or more embodiments of the invention can be implemented, according to an exemplary embodiment of the invention; and

FIG. 8 illustrates a distributed communications/computing network in accordance with which one or more embodiments of the invention can be implemented, according to an exemplary embodiment of the invention.

### DETAILED DESCRIPTION

Exemplary embodiments of the invention will now be discussed in further detail. This invention may, however, be embodied in many different forms and should not be construed as limited to the embodiments set forth herein.

As used herein, a network, can refer to, but is not necessarily limited to, a local area network (LAN), wide area network (WAN), cellular network, satellite network or the Internet. Network communication can be performed via one or more centralized servers or cloud data centers that receive, analyze and send data to and from one or more user devices, such as, for example, smart phones, tablets or other computing devices, that, by way of example, are part of the network.

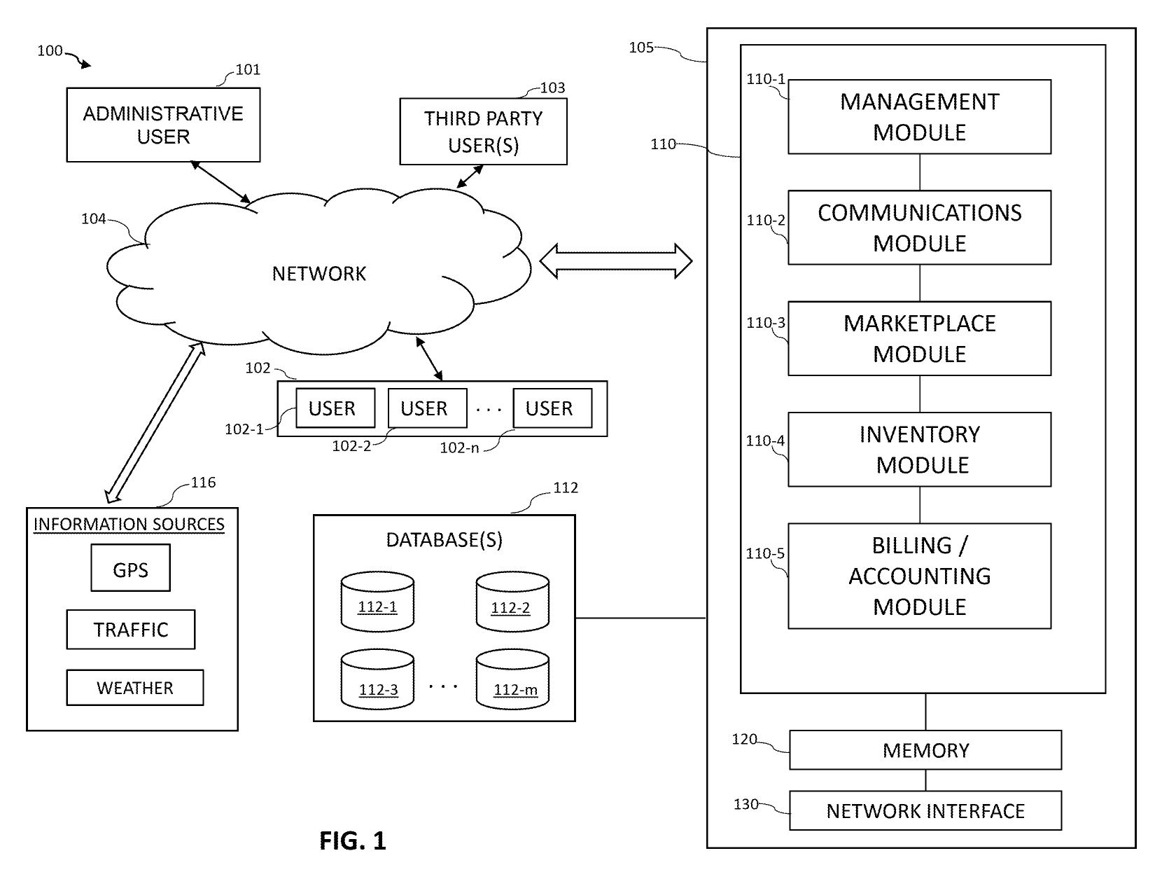

FIG. 1 is a block diagram of a system for administration of a construction entity according to an exemplary embodiment of the present invention. As shown in FIG. 1 by lines and/or arrows or by shapes within other shapes, the components of the system 100, or elements of each component, are operatively connected to each other via, for example, physical connections, such as wired and/or direct electrical contact connections, and/or wireless connections, such as, for example, Wi-Fi, BLUETOOTH, IEEE 802.11, and/or networks, including but not limited to, a local area network (LAN), wide area network (WAN), cellular network, ad hoc networks, wireless ad hoc network (WANET), satellite network or the Internet.

FIG. 1 illustrates an information processing system 100 implementing a construction management system 105. The information processing system 100 as shown includes multiple users who each may have a user device associated therewith, which may access the construction management system 105 over the network 104. A user device may include for example, a mobile computing device like a cell phone, a tablet computer, or a laptop computer. As shown in FIG. 1 the system may include an administrative user 101 and a plurality of non-administrative users 102, including users 102-1, 102-2, . . . 102-n. The users 101, 102, and 103 may communicate with each other over the network 104. The administrative user 101 and the non-administrative users 102 may, for example, comprise employees and/or managers and/or owners of a particular organization, e.g., a construction company. Also included are third party users 103. The third party users 103 may be, for example, vendors, subcontractors, etc. Although one administrative user 101 is shown, the embodiments of the present invention are not necessarily limited thereto, and there may be more than one administrative user.

For purposes of the present description, it is assumed there is a hierarchical relationship between the administrative user 101 and the plurality of users 102. That relationship may be defined by many exemplary paradigms found in a traditional employment context such as employer/employee, or project manager, superintendent, foreperson, and laborer. Additionally, according to the present embodiment the users 101, 102, and 103 may not have the same access capabilities within the system 100. That is, the users 101, 102, and 103 may have the ability to access different capabilities and functionalities of the various modules based on their position. For example, the administrative user 101 is considered in an embodiment to have the highest level of access and is able to access all or a majority of the system capabilities, whereas a non-administrative user 102 or a third party user 103 has limited access to specific capabilities of the construction management system 105.

The construction management system 105 operates within a computer system such as information processing system 100. The construction management system 105 includes a processor 110 operatively coupled to a memory 120. The memory may comprise Random Access Memory (RAM), Read-Only Memory (ROM), or other memories of the type usually utilized by an information processing system.

The processor 110 comprises a management module 110-1, a communications module 110-2, a marketplace module 110-3, an inventory module 110-4, and a billing/accounting module 110-5. The construction management system 105 communicates over a network 104 via network interface circuitry 130. As shown, the network interface circuitry is coupled to the memory 120 and processor 110.

Also shown in FIG. 1 is a database 112 comprising a plurality of sub-databases 112-1, 112-2, 112-3 . . . 112-m. Sub-database 112-1 may comprise employee information, such as telephone numbers, email addresses, and other contract information. Sub-database 112-2 may comprise equipment information, such as information on maintenance for a particular piece of heavy equipment, for example, a bulldozer or an excavator. Sub-database 112-3 may comprise information relating to billing and invoicing for a particular job. The database 112 is illustratively coupled to the construction management system 105. In illustrative embodiments of the present disclosure, the modules 110-1 through 110-5 may interface with the database 112 to obtain stored information or alternatively to store information for future usage.

Additionally shown in FIG. 1 are information sources 116. The information sources 116 illustratively comprise Global Positioning System (GPS) information, traffic information, and weather information. Such information is exemplary only and other embodiments may include additional or fewer information sources. The various modules 110-1 through 110-5 retrieve the information contained in information sources 116 over the network 104 via the network interface circuitry 130.

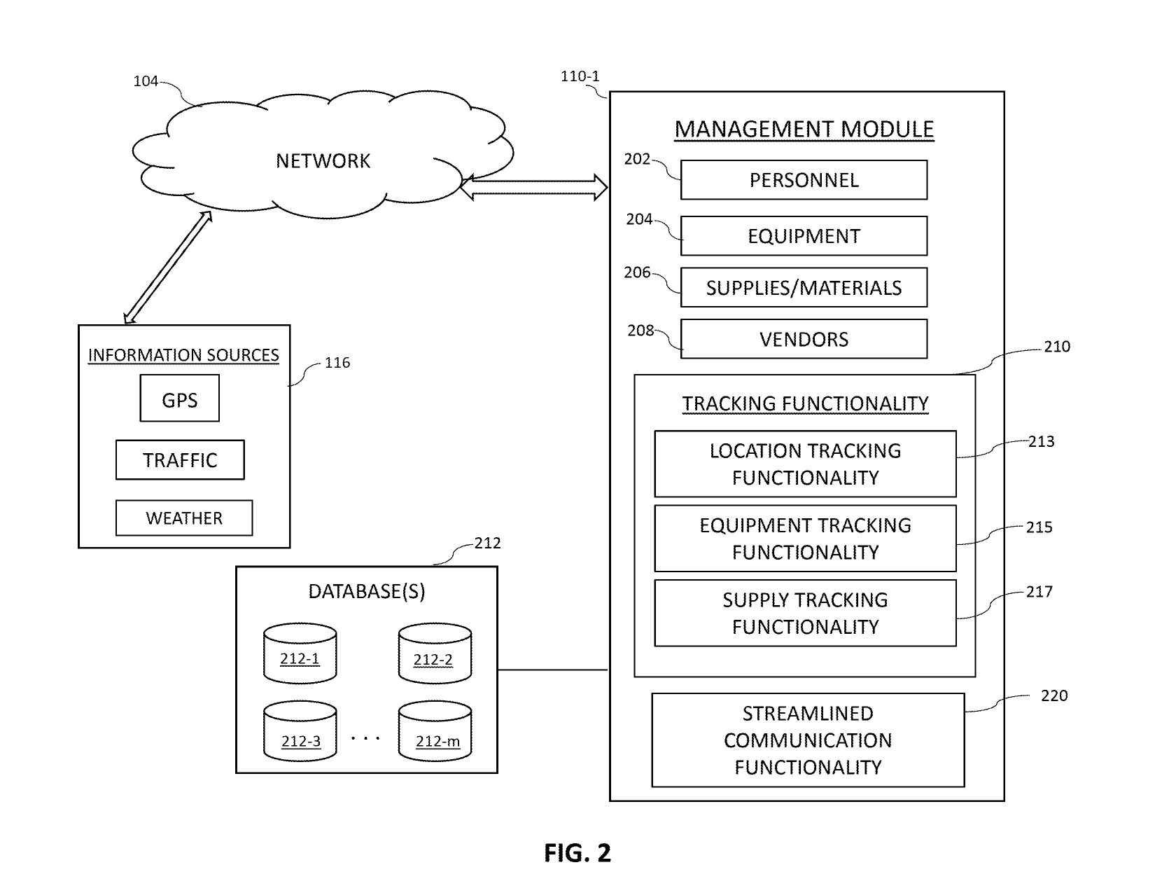

FIG. 2 illustrates an expanded version of the management module 110-1 of the construction management system 105. The management module 110-1 illustratively organizes the management of personnel data 202, equipment data 204, supplies/materials data 206, and vendor data 208. As mentioned above, the various users 101, 102, and 103 may be arranged in a hierarchical manner. It is assumed that the administrative user 101 is at the top of the hierarchical arrangement and that users 102 and 103 are below the administrative user. For purposes of explanation, the administrative user 101 is considered to have complete access to the management module 110-1, that is, the administrative user 101 is the manager and will utilize the functionality described herein to manage personnel data 202, equipment data 204, supplies/materials data 206 and vendor data 208. Although one administrative user is shown in FIG. 1, in some embodiments, there may be a plurality of administrative users, and each may have different access capabilities.

Management of personnel data 202 via the management module 110-1 in some embodiments allows the administrative user to monitor individual workers, this includes hours worked, worker credentials, and/or worker rule and safety violations. The management module, for example, may also permit an administrative user to determine how long personnel are spending on completing a specific task. Both the administrative user and the employee user may compile this information into one or more sub-databases 212-1, 212-2, 212-3 . . . 212-m of the database 212.

Management module 110-1 also includes tracking functionality 210. Tracking functionality 210 may comprise location tracking functionality 213, equipment tracking functionality 215, and supply tracking functionality 217. Tracking functionality 210 enables an administrative user to monitor the location of personnel, equipment, supplies/materials and vendors. The tracking functionality 210 of the management module 110-1 may communicate over the network 104 via the network interface circuitry 130 to obtain GPS information from information sources 116.

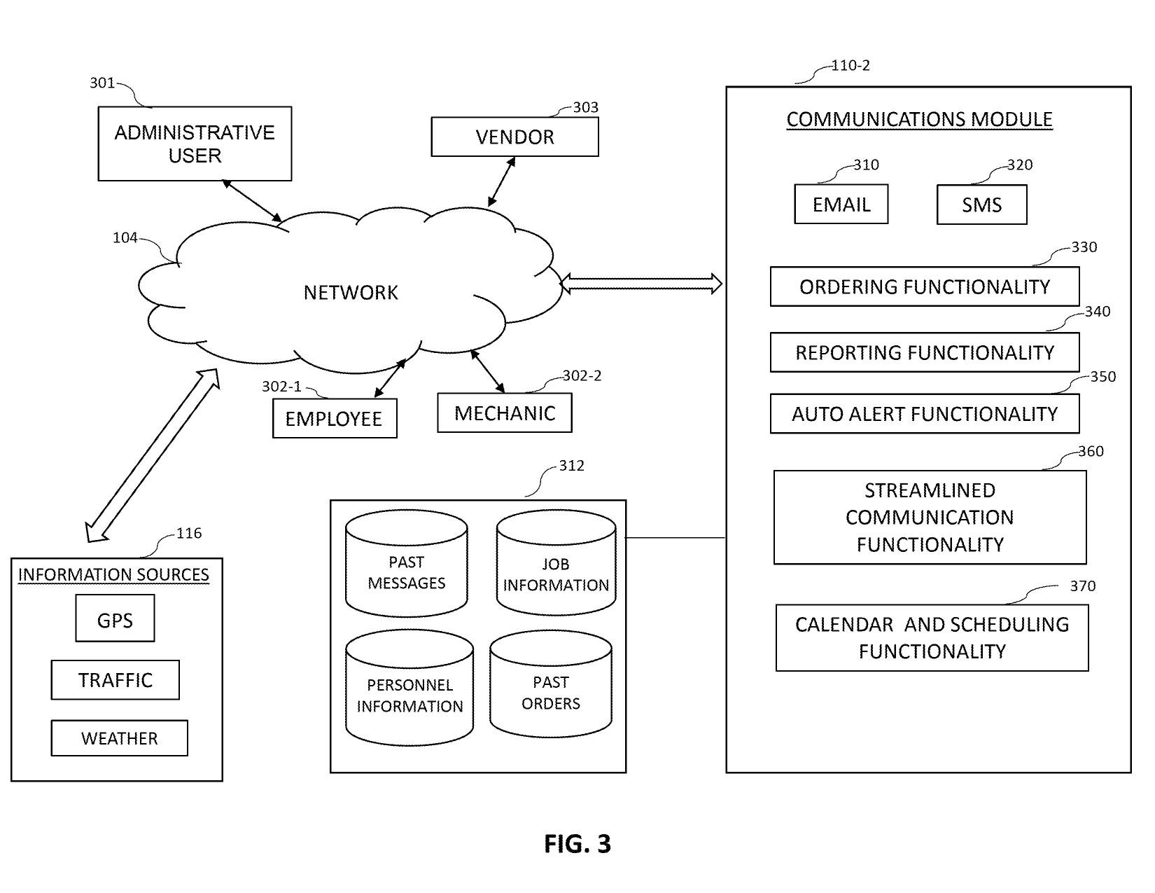

In an exemplary embodiment, the tracking-functionality 210 allows an administrative user 101 to determine via, for example, location services functionality in user devices, such as cell phones, etc., when personnel have arrived on a jobsite and to locate personnel using the location tracking functionality 213. The administrative user may also dispatch personnel utilizing the streamlined communication function 220, which will be discussed below in conjunction with communications module 110-2 (element 360 in FIG. 3). Additionally, the administrative user 101 may be able to determine where equipment, for example, heavy machinery, is located on a specific jobsite using equipment tracking functionality 215, which may rely on network communications with GPS devices in the equipment.

Equipment tracking functionality 215 in some embodiments may also comprise functionality to allow an administrative user to determine when equipment requires maintenance or repair. If the equipment is not owned but rented from a rental company, for example, a third party user 103, the equipment tracking functionality may utilize the streamlined communication functionality 220 to communicate with the third party user 103, i.e., the rental company, to initiate a repair.

In certain embodiments of the present disclosure, the equipment tracking functionality 215 and the supply tracking functionality 217 may comprise a barcode based inventory system. The inventory system would allow users, for example, to track equipment and supplies/materials within an organization. For example, a user 102 on a jobsite may scan a barcode on a supply/material to indicate via the supply tracking functionality 217 that a quantity of that supply has been used. The barcode information as well as the supply information may be stored in one of the plurality of databases 212. The supply tracking functionality 217 and the equipment tracking functionality may utilize GPS information of the information sources 116 to determine the location of equipment as well as supplies/materials. The supply tracking functionality may also utilize the streamlined communication functionality 220 to send alerts or messages to users 102 to prevent users 102 from losing supplies/materials or equipment.

In other embodiments of the present disclosure, the equipment tracking functionality may allow for a sensor such as a camera to take a photograph of equipment to document any defect with the equipment. That captured information is stored within one of the plurality sub-databases of database 212.

The supply tracking functionality 217 enables an administrative user in certain embodiments to select supplies/materials from a pre-populated list stored in a database 212. That list will be compiled, saved in the memory 120 and be accessible to a plurality of users 102. The supply tracking functionality 217 allows a user to determine what supplies/materials are in stock for a specific job at a specific jobsite, what equipment is on hand and what equipment is no longer needed. Therefore, a database 212 may be updated dynamically to ensure that all the information on available equipment and supplies/materials are accurate and accessible. The tracking functionality 210 of the management module 110-1 may in other embodiments be operative within or in conjunction with the inventory module 110-4.

In another embodiment, the supply tracking functionality 217 may also include a query functionality where a user may submit a query to determine which materials are needed for a particular job or operation. For example, a user may input a particular scope of work into the query functionality via an interface, and then the supply tracking functionality 217 will search a database 212 to determine what supplies/materials are needed for the queried work and/or which of the needed supplies/materials are in stock or need to be ordered.

FIG. 3 illustrates an expanded version of communications module 110-2 of the construction management system 105. As shown, communications module 110-2 may include email 310 and short message service (SMS) 320 capabilities to enable communications over a network such as network 104 in an illustrative embodiment of the present disclosure. Although not shown in FIG. 3, in certain embodiments of the present disclosure additional communication capabilities such as multi-media messaging or video conferencing may be utilized. It is noted that all communications sent and received via email 310 and SMS 320 capabilities will be stored in the past messages sub-database of database 312 as shown in FIG. 3. The email 310 and SMS 320 capabilities allow the administrative user 301 to communicate in this illustrative embodiment with a vendor 303, an employee 302-1, and a mechanic 302-2. The mechanic 302-2 in this illustrative embodiment may also be considered an employee, similar to employee 302-1, however for purposes of the foregoing discussion the mechanic 302-2 is called out specifically as a separate entity. The administrative user 301, vendor 303, employee 302-1 and mechanic 302-2 are all considered users of the construction management system 105 as described above.

In the illustrative embodiment depicted in FIG. 3 an exemplary database 312 is coupled to the communications module 110-2. The database 312 is an example of database 112 discussed above in conjunction with FIG. 1. The database 312 may contain a plurality of sub-databases including, for example, past message information, job information, personnel information, and past order information. The past message information sub-database may contain message data that has been sent and received. The job information sub-database may contain information regarding past and present construction type jobs including information about how a job should be performed and what tools, equipment and materials are required for a specific job or task. The personnel information sub-database may contain data and information regarding personnel including for example contact information, employment records, certifications, etc. The past orders sub-database may include data relating to orders of equipment, materials, or supplies including vendor information and pricing information. In other embodiments, additional sub-databases may be included in database 312.

In an illustrative embodiment, an administrative user 301 will be able to send a communication using email 310 or SMS 320 capabilities to an employee 302-1. The administrative user 301 may select a message from the past messages sub-database 312 and send that message directly to the employee 302-1. For example, that message could be an instruction to bring certain tools or equipment to a jobsite. An administrative user 301 may also be able to directly communicate with a mechanic 302-2 and instruct the mechanic 302-2 to repair a broken-down piece of equipment on a jobsite.

In another illustrative embodiment, an administrative user 301 may communicate using email 310 or SMS 320 capabilities with a vendor 303. An equipment rental company may be an example of a vendor 303. The administrative user 301 may instruct a vendor 303, such as an equipment rental company, to pick-up or drop-off a certain piece of rental equipment. The administrative user may also include location information from the GPS of information sources 116 in the communication to direct the vendor 303 where to leave or where to find a specific piece of equipment.

It is noted that the employee 302-1, the mechanic 302-2 and the vendor 303 may also communicate with the administrative user 301 or communicate amongst or between themselves. For example, the employee 302-1 may be an operator of a piece of heavy machinery. If that piece of heavy machinery breaks-down, the employee 302-1 may communicate using SMS 302 with a mechanic 302-2 to alert the mechanic to the break-down and request that the mechanic 302-2 repair the piece of heavy machinery.

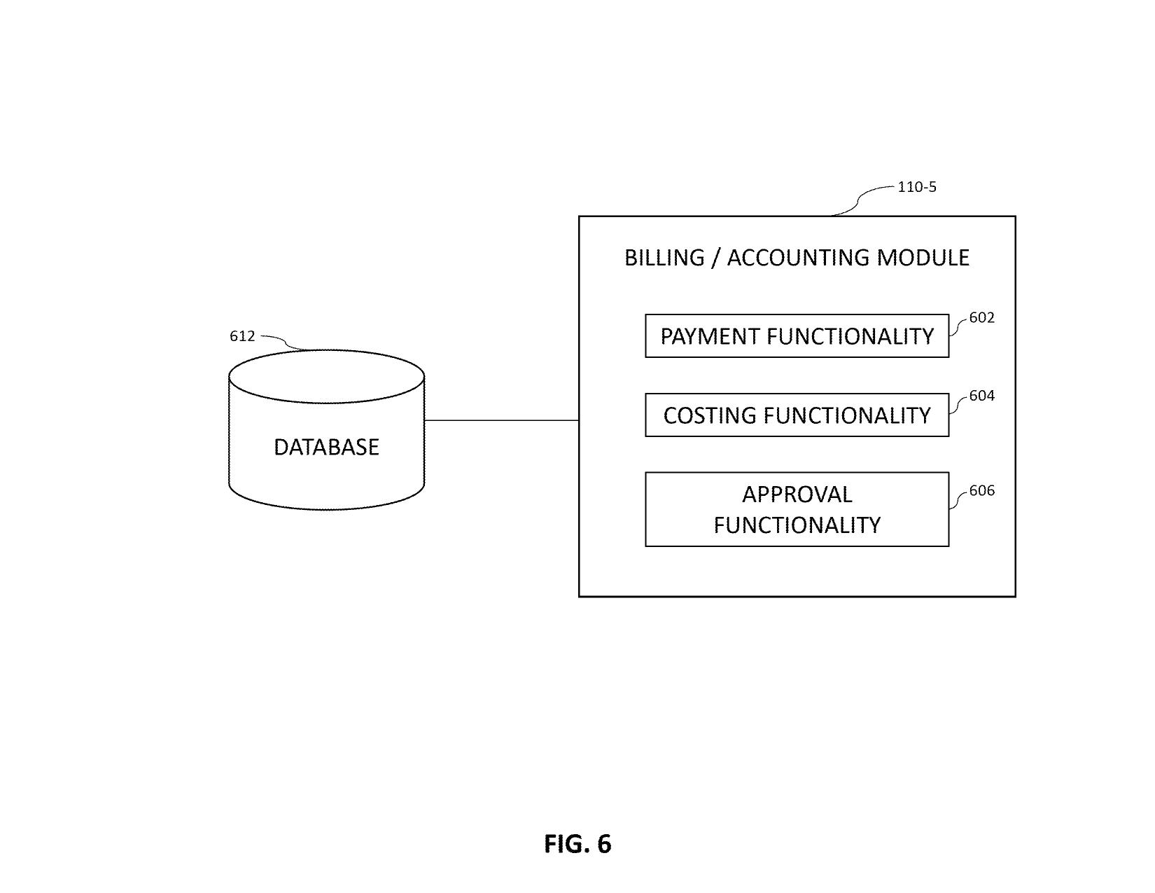

In the illustrative embodiment of FIG. 3, the communications module 110-2 also includes ordering functionality 330 and reporting functionality 340. The ordering functionality 330 allows an administrative user 301 or an employee 302-1 to order or request specific materials for a job. The materials may be owned by the organization or they may be purchased from another entity, such as vendor 303. The ordering functionality may utilize the past orders sub-database from the database 312 to quickly access past items ordered which will assist the ordering process. The ordering functionality 330 may include in some exemplary embodiments a review and approval capability similar to approval functionality 606 discussed below in conjunction with FIG. 6 so when an employee 302-1 requests an item, an administrative user may either permit or deny the request. If the request is allowed the item ordered will be purchased, and/or sent to a specific jobsite. Additionally, in some embodiments, the ordering functionality 330 will permit an employee 302-1 to order from a third party provider or another employee to send equipment or trucks to a jobsite. The reporting functionality 340 allows an employee 302-1 to report, for example, a job-site accident, safety issue or violation to an administrative user 301. The reporting functionality 340 additionally permits the employee 302-1 to report a mechanical issue or other such issues on a jobsite.

The communications module 110-2 may also comprise auto alert functionality 350. Auto alert functionality automatically sends messages to employees such as employee 302-1 when a certain predefined event occurs. A predefined event may include, for example, inclement weather, and/or a change in traffic conditions. In an exemplary embodiment, an administrative user 301 may program the auto alert functionality to send a message to all users associated with a specific project, such as employee 302-1, when the ambient temperature outdoors is above or below certain threshold temperatures that may prevent a job from being completed. The auto alert functionality will receive information on the weather from information sources 116 and when the threshold is met, the auto alert functionality will send out an alert, for example, via email 310 or SMS 320 cancelling a job to be performed outdoors, for example a road paving job.

The auto alert functionality 350 may also be configured to alert an employee 302-1 or vendor 303 who may be delivering equipment or traveling to a jobsite as to whether a roadway is closed to traffic or otherwise inaccessible. The auto alert functionality 350 may receive traffic information from information sources 116 over the network 104. If the traffic information indicates that a certain roadway is inaccessible, the auto alert functionality 350 will send an automatic alert to the employee 302-1 or vendor 303 indicating such and providing alternative directions for arriving to a jobsite.

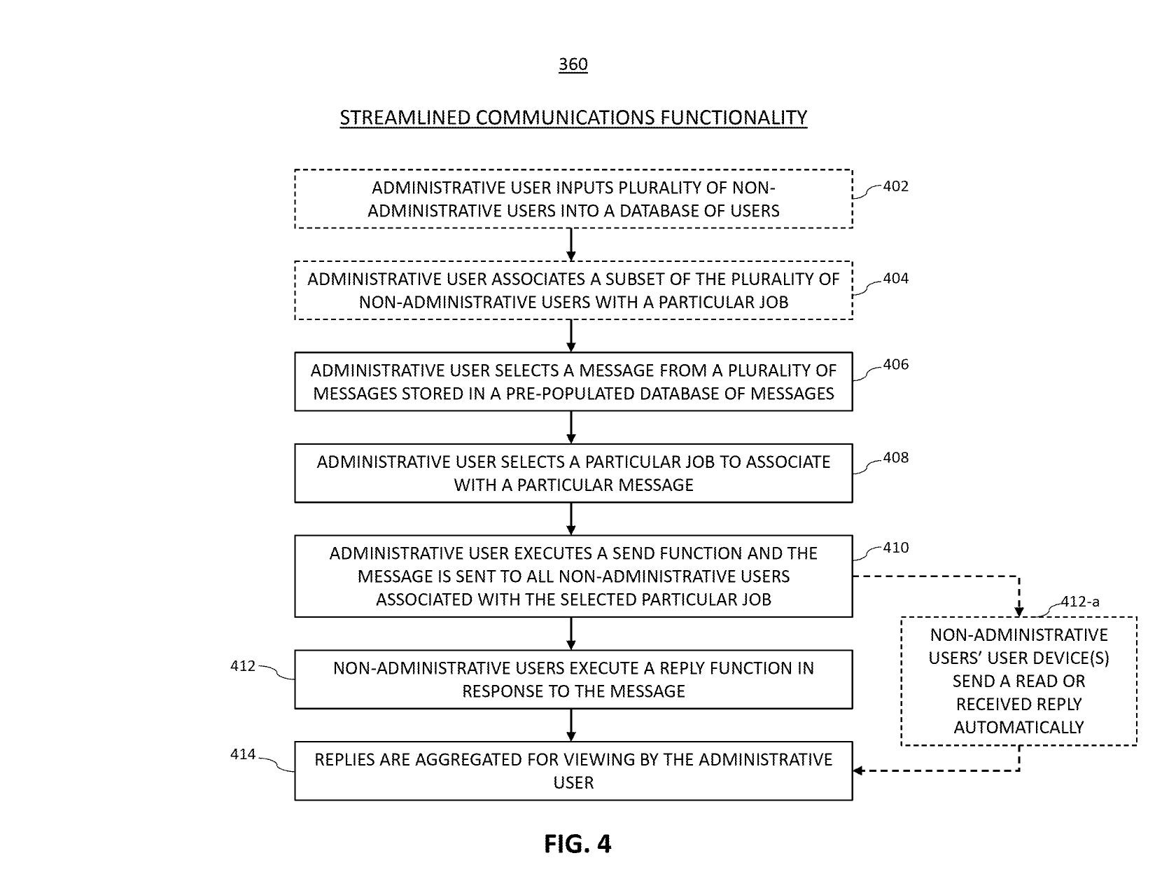

FIG. 3 additionally illustratively includes streamlined communication functionality 360 (which is similar to the streamlined communication functionality 220 discussed above in reference to FIG. 2). Streamlined communication functionality 360 permits communication amongst and between the users 301, 302-1, 302-2, and 303 in an efficient manner. For example, streamlined communication functionality 360 reduces the number of actions (e.g., keystrokes, mouse clicks, pointing, touchscreen contacts, etc.) required to generate and transmit communications between users. As will be described further in connection with FIG. 4, the streamlined communication functionality 360 will allow users 301, 302-1, 302-2, and 303 to, for example, use one, two or three actions when sending a message. For example, a user may take one action to send a message to multiple users and simultaneously receive an aggregated and optionally automatic reply confirming receipt of a message. Some non-limiting examples may include, but are not necessarily limited to, using one or a limited number of actions (e.g., keystroke, mouse click, pointing, touchscreen contact, etc.) to cancel a job, dispatch workers to a jobsite location, and/or dispatch equipment to a jobsite.

FIG. 4 is a flow chart illustrating the operation of the streamlined communications functionality 360 according to a non-limiting illustrative embodiment. FIG. 4 includes steps 402-414. The process begins at step 402 when an administrative user inputs the contact information of a plurality of non-administrative users into a database of users, such as database 312 containing a personnel information sub-database. Next, in step 404 the administrative user associates a subset of the plurality of non-administrative users with a particular job. It is important to note that steps 402 and 404 do not necessarily need to be performed every time an administrative user wishes to send a message to a plurality of users, and are illustrated in boxes having dotted lines. These steps may be performed once and the information inputted in steps 402 and 404 may be updated as needed. The process then continues in step 406 when the administrative user selects a message from a plurality of messages stored in a pre-populated database of messages, such as the past messages sub-database of database 312. Such a message could indicate, for example: (i) that a job is canceled and no employees should report to the jobsite for the day; (ii) that specific employees should report to a specific worksite at a specific time and/or date; (iii) that specific safety precautions should be observed; or (iv) that certain pieces of equipment and/or materials must be gathered from an off-site location and brought to the jobsite. Next, in step 408 the administrative user will then select a particular job to associate with the message selected in step 406. The administrative user will execute a send function in step 410 and the message will be sent to all non-administrative users associated with the selected job. In step 412 the non-administrative users, who are recipients of the message sent in step 410, execute a reply function in response to that message. Optionally, the user device of the non-administrative user may automatically send a read or received reply to the message in step 412-a. Finally, in step 414 the replies are aggregated for viewing by the administrative user. Alternatively, an administrative user may be interfacing with the system in connection with a particular job, and the system will recognize that the user is interfacing with the system for that particular job, so that upon selection of a message from a plurality of messages stored in a pre-populated database of messages in step 406, the system can automatically send the selected message to the users associated with the particular job.

Referring back to FIG. 3 also included in communications module 110-2 is calendar and scheduling functionality 370. Calendar and scheduling functionality 370 in exemplary embodiments permits an administrative user 301 to input specific tasks and jobs into a calendar so that they are visible to all selected users such as employee 302-1. The calendar and scheduling functionality will inform the administrative user 301 of any conflicts within a schedule and will provide the user with reminders and alerts, which are pre-programmed into the system. The calendar and scheduling functionality 370 displays the calendar information allowing the administrative user 301 as well as other users to view the calendar in advance of upcoming events. In some embodiments, when a job is canceled, the cancellation of the job is input into the calendar via the calendar and scheduling functionality 370 and that input will trigger the auto alert functionality 350 to send a communication informing all users associated with a specific job of its cancellation. This also applies any time the schedule or timeline for a job is altered.

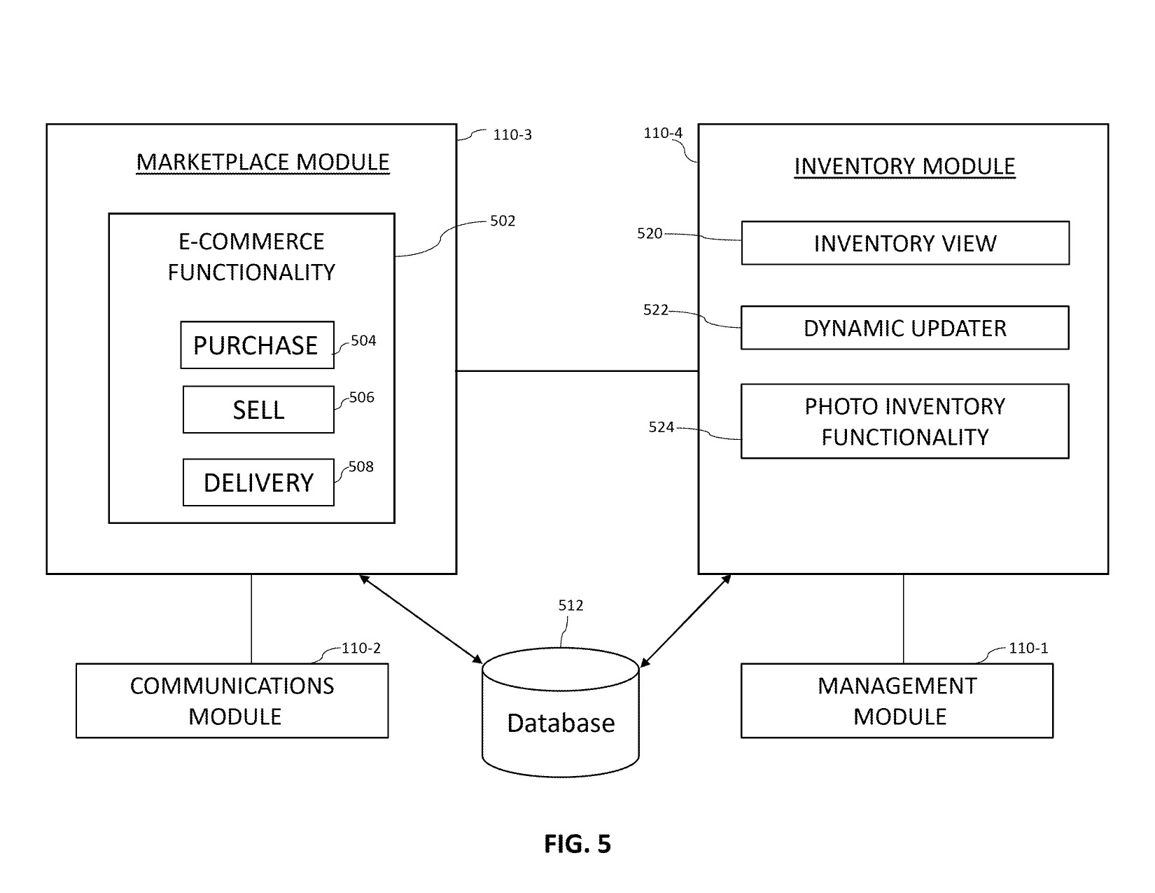

FIG. 5 illustrates an expanded version of marketplace module 110-3 and inventory module 110-4 of the construction management system 105. As shown in FIG. 5 and as described above the inventory module 110-4 operates in conjunction with the management module 110-1. The inventory module comprises inventory view functionality 520, dynamic updater functionality 522 and photo inventory functionality 524. As shown the inventory module 110-4 and the marketplace module 110-3 are both coupled to a database 512. Database 512 may be configured in a manner similar to the databases 112, 212 and 312 as described above.

The inventory view functionality 520 allows users (as described above) to see a visual representation of the inventory of materials and supplies that an organization may have on hand. The inventory view functionality 520 allows a user to determine whether the required material or supply is located at a jobsite or at another location.

The inventory module 110-4 also illustratively comprises dynamic updater functionality 522. The dynamic updater functionality 522 employs, for example, a barcode or similar functionality of the type discussed above to dynamically update the inventory. A user who uses a specific material may scan a barcode and indicate that a material is in use or is being depleted. The dynamic updater functionality 522 will then update the inventory list stored in database 512. In addition, if the inventory of certain materials falls below a predetermined threshold, the inventory module 110-4 can automatically communicate with the management module 110-1 and/or the communications module 110-2 to use supply tracking and/or ordering functionality 217, 330 to automatically re-order the materials that are in short supply. The dynamic updater 522 and the inventory view functionality 520 will pull data from and store data in database 512 to ensure that the data is accessible.

The inventory module 110-4 in some embodiments comprises photo inventory functionality 524. The photo inventory functionality 524 allows a user to take a photographic image of a material, such as, but not necessarily limited to, a road plate, and the photo inventory functionality 524 will determine the size parameters of the exemplary road plate. According to an embodiment of the present invention, the photo inventory functionality 524 will permit measurement using, for example, camera functionality associated with a smartphone and/or a tablet, and calculate dimensions of an object using geometrical factors (e.g., Pythagorean Theorem) based on camera height, camera angle and camera distance from the object.

Alternatively, or in addition, using comparisons to a populated database of images of, for example, construction materials and equipment, the photo inventory functionality 524 would be able to determine which material or piece of equipment is pictured, and derive a description of the material or piece of equipment simply from a captured image of the material or piece of equipment. This would enable a user in the field (e.g., at a jobsite) to avoid having to physically measure or describe materials or equipment that need to be ordered for a particular job.

Also shown in FIG. 5 is the electronic commerce (e-commerce) functionality 502 of the marketplace module 110-3. The marketplace module 110-3 works in conjunction with the inventory module 110-4 as well as the ordering functionality 330 (FIG. 3) of communications module 110-2. The e-commerce functionality 502 allows users to purchase using purchasing functionality 504, sell using sell functionality 506 and arrange for delivery using the delivery functionality 508 of certain materials. In an exemplary embodiment, an administrative user will use the inventory view 520 of the inventory module 110-4 to determine what materials from the organization's inventory are excess or no longer needed. The administrative user will then be able to list that material for sale using the sell functionality 506. Other third party users, not associated with the first organization will be able to utilize the e-commerce functionality to purchase the listed materials using the purchasing functionality 504. Both the seller and the purchasers may be able to arrange for delivery utilizing the delivery functionality 508.

Obtaining the best savings on material is often one of the biggest feats to overcome in successfully managing a construction project. Project management and procurement staff spend countless hours making phone calls, sending solicitation emails, and making follow up phone calls to try to obtain competitive pricing for a vast array of products and materials. In accordance with an embodiment of the present invention, the construction management system 105 associated with, for example, the marketplace module 110-3, will include a sales-bid feature that will streamline the procurement process and include one-click (or minimal click) bidding/purchasing.

Similar to known online auction companies (i.e. eBay®), users can include, but are not necessarily limited to, well-known and established vendors and end user purchasers who are seeking the best price for certain products and materials (e.g., contractors, public agencies, private developers, etc.). The end user purchasers will submit via for example, their user devices, the specific parameters of their order, which may include, but are not necessarily limited to, product/material description, quantity, and date when shipment is needed. Once the end user purchaser submits their order, the order is then able to be electronically accessed by vendors who are interested in bidding on the order by giving, for example, the lowest possible price that satisfies the end user purchaser's order requirements. Vendors will be given chances to bid in real-time on the order until it reaches the expiry set by the end user. As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment of the invention is implemented, other appropriate timescales that provide at least contemporaneous performance and output can be achieved.

The construction management system 105 associated with, for example, the marketplace module 110-3, will also include a feature that automatically lets vendors know that other vendors are actively submitting bids, but the information that is provided to the vendors will be limited based on confidentiality concerns in the bidding process, and can include, for example, the contact details of the bidding vendor. In accordance with an embodiment of the present invention, a vendor may receive an automatic alert, for example, in the form an email or SMS message, alerting them of other active bids in connection with services or products that the vendor has already bid on. The alert may include, for example, the contact details of the bidding vendor, a description of the subject of the bid, and information about when the bid was submitted. Vendors will also be able to add contingencies to their bids, for example, stating that the price is contingent upon payment within 30, 60, or 90 days and that pricing can be more competitive based on the shorter duration of payment term.

The construction management system 105 associated with, for example, the marketplace module 110-3, can also include a feature that permits advertisements and functionality to collect subscription fees that will be charged to sellers and purchasers. As a result, revenue will be generated from in application advertisements, as well as subscription fees. Vendors may also be charged additional percentages based on the size of the orders they fulfill to the end user purchasers. Vendors can also be given discounted subscription fees if they are active advertisers and if they are active in submitting bids in order to increase application exposure and drive competition. In accordance with an embodiment of the present invention, the construction management system 105 associated with, for example, the marketplace module 110-3, can also include a feature that records a number of advertisements and/or bids placed by a vendor, and if the number exceeds a predetermined threshold number of advertisements and/or bids, automatically provide the vendor with a discount.

FIG. 6 illustrates an expanded version of billing/accounting module 110-5 of the construction management system 105. The billing/accounting module 110-5 illustratively comprises payment functionality 602, costing functionality 604 and approval functionality 606. Similar to the modules 110-1 through 110-4 described above, the billing/accounting module 110-5 is operatively coupled to a database 612. The database 612 is similar to the databases 112, 212, 312 and 512 described above and may comprise sub-databases. The payment functionality 602, the costing functionality 604 and approval functionality 606 may all have access to query the database 612 to search for certain pieces of information such as previously paid invoices, previously purchased materials and supplies, cost codes, etc.

The payment functionality 602 allows a user or a plurality of users as described above to seek payment for or to pay certain outstanding invoices. The payment functionality may operatively be coupled to an image capture device, such as a scanner, which captures data contained on invoices. The invoices are compiled in the database 612 along with other accounting/bookkeeping documents or materials. Once a user indicates that an invoice has been paid, the database 612 will be updated to indicate that payment has been made. In some instances, the image capture device will capture the payment instrument, such as a check, and that capture will be linked to the invoice and will update database 612 to indicate that the invoice was paid.

In addition, the payment functionality 602 permits users (e.g., administrative users 101) to access the database 612 for pre-populated or pre-signed approval and/or verification forms and documents. For example, vendors may require that an administrative user fill-out and sign certain authorization forms and/or provide copies of identification (e.g., driver's licenses) or credit cards before approving an order for materials or equipment. The payment functionality 602 can access the database 612 for such authorization forms, identification or credit cards so that an administrative user more readily can provide or modify these forms (e.g., when not in an office) for the vendor without having to fill out a new form or obtain new copies of identification or credit cards.

The costing functionality 604 allows a user to input a cost code or billing code and associate that cost code with a certain activity. For example, if an employee utilizes a piece of heavy equipment to perform a job on a jobsite, that employee may input that information into the costing functionality 604 so that it will be organized for future billing.

The approval functionality 606 allows an administrative user to view all inputted information before an invoice is paid through the payment functionality 602. The approval functionality 606 may also be utilized to approve outstanding purchase orders. All invoices and costs from the payment functionality 602 and the costing functionality are all reviewed by an administrative user in one interface and then the administrative user may approve or deny the payments or purchase.

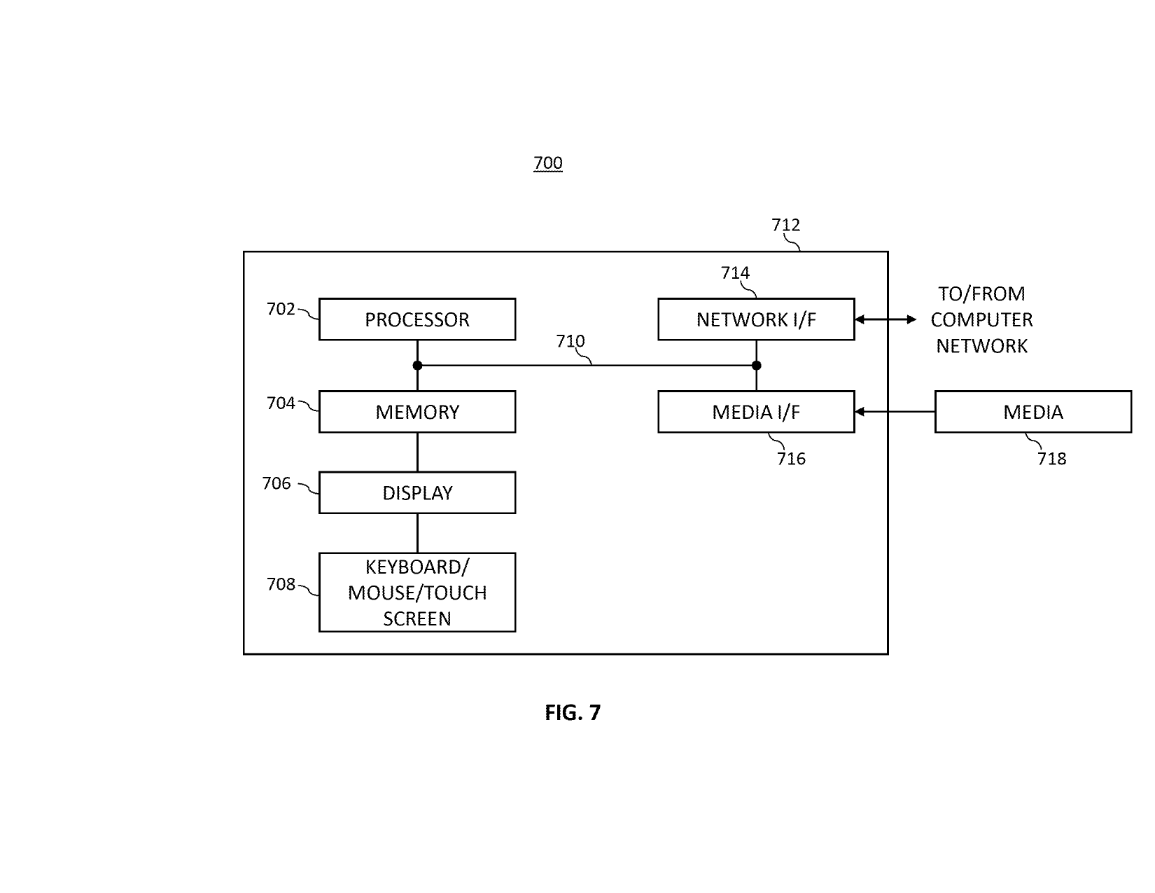

FIG. 7 illustrates a computer system 700 in accordance with which one or more embodiments of a model management system can be implemented. That is, one, more than one, or all of the components and/or functionalities shown and described in the context of FIGS. 1-6 can be implemented via the computer system depicted in FIG. 7.

By way of illustration, FIG. 7 depicts a processor 702, a memory 704, and an input/output (I/O) interface formed by a display 706 and a keyboard/mouse/touchscreen 708. More or less devices may be part of the I/O interface. The processor 702, memory 704 and I/O interface are interconnected via computer bus 710 as part of a processing unit or system 712 (such as a computer, workstation, server, client device, etc.). Interconnections via computer bus 710 are also provided to a network interface 714 and a media interface 716. Network interface 714 (which can include, for example, transceivers, modems, routers and Ethernet cards) enables the system to couple to other processing systems or devices (such as remote displays or other computing and storage devices) through intervening private or public computer networks (wired and/or wireless). Media interface 716 (which can include, for example, a removable disk drive) interfaces with media 718.

The processor 702 can include, for example, a central processing unit (CPU), a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 702. Memory 704 (or other storage device) having such program code embodied therein is an example of what is more generally referred to herein as a processor-readable storage medium. Articles of manufacture comprising such processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 704 may comprise electronic memory such as random access memory (RAM), read-only memory (ROM) or other types of memory, in any combination. The one or more software programs when executed by a processing device such as the processing unit or system 712 causes the device to perform functions associated with one or more of the components/steps of system/methodologies in FIGS. 1-6. One skilled in the art would be readily able to implement such software given the teachings provided herein. Other examples of processor-readable storage media embodying embodiments of the invention may include, for example, optical or magnetic disks.

Still further, the I/O interface formed by devices 706 and 708 is used for inputting data to the processor 702 and for providing initial, intermediate and/or final results associated with the processor 702.

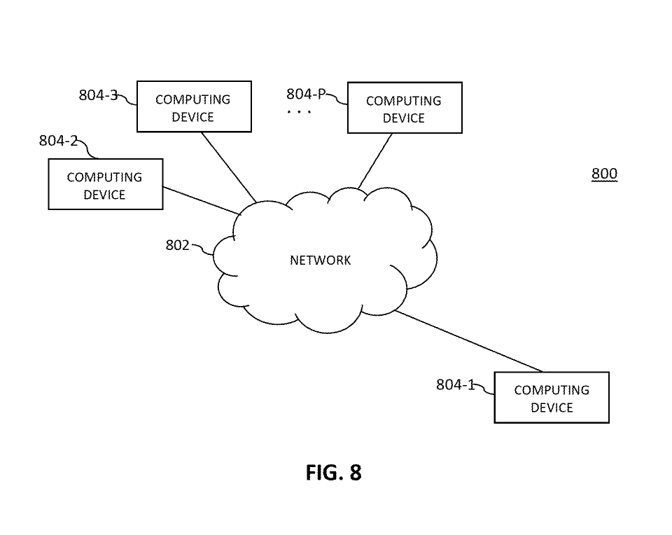

FIG. 8 illustrates a distributed communications/computing network (processing platform) in accordance with which one or more embodiments of the invention can be implemented. By way of illustration, FIG. 8 depicts a distributed communications/computing network (processing platform) 800 that includes a plurality of computing devices 804-1 through 804-P (herein collectively referred to as computing devices 804) configured to communicate with one another over a network 802.

It is to be appreciated that one, more than one, or all of the computing devices 804 in FIG. 8 may be configured as shown in FIG. 7. It is to be appreciated that the methodologies described herein may be executed in one such computing device 804, or executed in a distributed manner across two or more such computing devices 804. It is to be further appreciated that a server, a client device, a processing device or any other processing platform element may be viewed as an example of what is more generally referred to herein as a “computing device.” The network 802 may include, for example, a global computer network such as the Internet, a wide area network (WAN), a local area network (LAN), a satellite network, a telephone or cable network, or various portions or combinations of these and other types of networks (including wired and/or wireless networks).

As described herein, the computing devices 804 may represent a large variety of devices. For example, the computing devices 804 can include a portable device such as a mobile telephone, a smart phone, personal digital assistant (PDA), tablet, computer, a client device, etc. The computing devices 804 may alternatively include a desktop or laptop personal computer (PC), a server, a microcomputer, a workstation, a kiosk, a mainframe computer, or any other information processing device which can implement any or all of the techniques detailed in accordance with one or more embodiments of the invention.

One or more of the computing devices 804 may also be considered a “user.” The term “user,” as used in this context, should be understood to encompass, by way of example and without limitation, a user device, a person utilizing or otherwise associated with the device, or a combination of both. An operation described herein as being performed by a user may therefore, for example, be performed by a user device, a person utilizing or otherwise associated with the device, or by a combination of both the person and the device, the context of which is apparent from the description.

Additionally, as noted herein, one or more modules, elements or components described in connection with embodiments of the invention can be located geographically-remote from one or more other modules, elements or components. That is, for example, the modules, elements or components shown and described in the context of FIGS. 1-6 can be distributed in an Internet-based environment, a mobile telephony-based environment, a kiosk-based environment and/or a local area network environment. The model management system, as described herein, is not limited to any particular one of these implementation environments. However, depending on the operations being performed by the system, one implementation environment may have some functional and/or physical benefits over another implementation environment.

The processing platform 800 shown in FIG. 8 may comprise additional known components such as batch processing systems, parallel processing systems, physical machines, virtual machines, virtual switches, storage volumes, etc. Again, the particular processing platform shown in this figure is presented by way of example only, and may include additional or alternative processing platforms, as well as numerous distinct processing platforms in any combination. Also, numerous other arrangements of servers, clients, computers, storage devices or other components are possible in processing platform 800.

Furthermore, it is to be appreciated that the processing platform 800 of FIG. 8 can comprise virtual machines (VMs) implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 800 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It is to be appreciated that combinations of the different implementation environments are contemplated as being within the scope of embodiments of the invention. One of ordinary skill in the art will realize alternative implementations given the illustrative teachings provided herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Additionally, the terms “comprises” and/or “comprising,” as used herein, specify the presence of stated values, features, steps, operations, modules, elements, and/or components, but do not preclude the presence or addition of another value, feature, step, operation, module, element, component, and/or group thereof.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. An apparatus comprising:
at least one processor coupled to a memory;
the at least one processor being configured:
to interface with at least one administrative user of an organization and a plurality of non-administrative users;
to associate a subset of the plurality of non-administrative users with a job being performed by the organization; and
to transmit one or more messages from the at least one administrative user to the subset of the plurality of non-administrative users associated with the job;
wherein in transmitting the one or messages, the at least one processor is configured:
to receive an input from the at least one administrative user associating the one or messages with the job; and
to assign the subset of the plurality of non-administrative users associated with the job as recipients of the one or more messages in response to the input from the at least one administrative user.

2. The apparatus of claim 1, wherein the at least one processor is further configured:
to maintain a database of a plurality of messages; and
to present to the at least one administrative user the plurality of messages for selection as the one or more messages.

3. The apparatus of claim 2, wherein the at least one processor is further configured:
to receive from the at least one administrative user a selection of at least one message of the plurality of messages as the one or more messages; and
to automatically transmit the one or more messages to the subset of the plurality of non-administrative users associated with the job in response to the selection.

4. The apparatus of claim 1, wherein the at least one processor is further configured:
to receive an input from the at least one administrative user canceling the job; and
to automatically transmit a message to the subset of the plurality of non-administrative users associated with the job alerting the subset of the plurality of non-administrative users of the cancellation.

5. The apparatus of claim 1, wherein the at least one processor is further configured:
to automatically monitor one or more external conditions affecting the job;
to determine an occurrence of the one or more external conditions; and
to automatically transmit a message to the subset of the plurality of non-administrative users associated with the job indicating a modification to the job in response to the determination of the occurrence of the one or more external conditions.

6. The apparatus of claim 5, wherein the one or more external conditions comprise a threshold temperature at a jobsite, and the message indicates a cancellation of the job in response to reaching the threshold temperature.

7. The apparatus of claim 5, wherein the one or more external conditions comprise a problem associated with a route to a jobsite, and the message indicates at least one of the problem associated with the route and an alternate route to the jobsite in response to occurrence of the problem associated with the route.

8. The apparatus of claim 1, wherein the at least one processor is further configured:
to receive a query from at least one of the at least one administrative user and at least one non-administrative user of the plurality of non-administrative users indicating work to be performed; and
to respond to the query with at least one of supplies and materials needed for the work.

9. The apparatus of claim 8, wherein the at least one processor is further configured to indicate which of the needed supplies or materials are in stock by the organization in response to the query.

10. The apparatus of claim 1, wherein the at least one processor is further configured to derive a description of at least one of material and equipment needed for the job from a photographic image of at least one of the material and the equipment.

11. The apparatus of claim 10, wherein the derived description comprises a size of at least one of the material and the equipment.

12. The apparatus of claim 1, wherein the at least one processor is further configured to receive competitive bids in real-time from a plurality of vendors for supplying at least one of material and equipment needed for the job.

13. The apparatus of claim 1, wherein the at least one processor is further configured:
to receive an image of a payment instrument for an invoice;
to link the image to the invoice; and
to update a status of the invoice to indicate that the invoice has been paid.

14. The apparatus of claim 1, wherein the at least one processor is further configured:
to receive a plurality of reply messages to the one or more messages from the subset of the plurality of non-administrative users associated with the job; and
to aggregate the plurality of reply messages for viewing by the at least one administrative user.

15. A method for managing an organization comprising:
interfacing with at least one administrative user of the organization and a plurality of non-administrative users;
associating a subset of the plurality of non-administrative users with a job being performed by the organization; and
transmitting one or more messages from the at least one administrative user to the subset of the plurality of non-administrative users associated with the job;
wherein transmitting the one or messages comprises:
receiving an input from the at least one administrative user associating the one or messages with the job; and
assigning the subset of the plurality of non-administrative users associated with the job as recipients of the one or more messages in response to the input from the at least one administrative user; and
wherein the steps of the method are performed by at least one processor coupled to a memory.

16. The method of claim 15, further comprising:
maintaining a database of a plurality of messages; and
presenting to the at least one administrative user the plurality of messages for selection as the one or more messages.

17. The method of claim 16, further comprising:
receiving from the at least one administrative user a selection of at least one message of the plurality of messages as the one or more messages; and
automatically transmitting the one or more messages to the subset of the plurality of non-administrative users associated with the job in response to the selection.

18. The method of claim 15, further comprising:
automatically monitoring one or more external conditions affecting the job;
determining an occurrence of the one or more external conditions; and
automatically transmitting a message to the subset of the plurality of non-administrative users associated with the job indicating a modification to the job in response to the determination of the occurrence of the one or more external conditions.

19. A computer program product comprising a non-transitory processor-readable storage medium having stored therein program code of one or more software programs, wherein the program code when executed by at least one processing device cause the at least one processing device:
to interface with at least one administrative user of an organization and a plurality of non-administrative users;
to associate a subset of the plurality of non-administrative users with a job being performed by the organization; and
to transmit one or more messages from the at least one administrative user to the subset of the plurality of non-administrative users associated with the job;
wherein in transmitting the one or messages, the program code further causes the at least one processing device:
to receive an input from the at least one administrative user associating the one or messages with the job; and
to assign the subset of the plurality of non-administrative users associated with the job as recipients of the one or more messages in response to the input from the at least one administrative user.

20. The computer program product according to claim 19, wherein the program code further causes the at least one processing device:
to automatically monitor one or more external conditions affecting the job;
to determine an occurrence of the one or more external conditions; and
to automatically transmit a message to the subset of the plurality of non-administrative users associated with the job indicating a modification to the job in response to the determination of the occurrence of the one or more external conditions.
